(19) United States
(12) Patent Application Publication
(10) Pub. No.: US 2013/0159916 A1
(43) Pub. Date: Jun. 20, 2013

(54) INFORMATION-PROCESSING DEVICE, CONTROL METHOD FOR INFORMATION-PROCESSING DEVICE, PROGRAM, AND RECORDING MEDIUM

(71) Applicants: Minoru Wadayama, Osaka-shi (JP); Kohji Akasaka, Osaka-shi (JP); Hiroshi Fukutomi, Osaka-shi (JP)

(72) Inventors: Minoru Wadayama, Osaka-shi (JP); Kohji Akasaka, Osaka-shi (JP); Hiroshi Fukutomi, Osaka-shi (JP)

(73) Assignee: SHARP KABUSHIKI KAISHA, Osaka-shi, Osaka (JP)

(21) Appl. No.: 13/819,682

(22) PCT Filed: Oct. 4, 2011
(86) PCT No.: PCT/JP2011/072883

§ 371 Date: Feb. 27, 2013

(30) Foreign Application Priority Data
Oct. 15, 2010 (JP) 2010-233003

(51) Int. Cl. G06F 3/0483

(52) U.S. Cl. CPC G06F 3/0483
USPC 715/776

(57) ABSTRACT

An information processing device of the present invention includes: a selected region image display processing section (17) for (i) generating a selecting object which includes a partial image designated by a user operation and (ii) displaying the selecting object thus generated; and a shift and copy managing section (18) for, according to an operation of determining a position of the selecting object, copying or shifting, to the position determined by the operation, the partial image on the basis of which the selecting object is generated. When a page on which the selecting object is displayed is changed to another page, the selected region image display processing section (17) displays the selecting object on the another page.

### TECHNICAL FIELD

The present invention relates to a user interface of an information processing device, the user interface which is capable of changing an image by page-based change. The present invention more specifically relates to a user interface for copying or shifting a part of an image to the image or another image.

### BACKGROUND ART

Conventionally, as computers are in widespread use, various user interfaces have been developed so that users can operate the computers more intuitively. For example, Patent Literature 1 discloses a technique of scrolling a background other than an object on a multipoint detectable touch panel while fixing the object to where the object is displayed. The scrolling is carried out according to an instruction of scrolling the background by touching and sliding the background while, by touching the object, fixing the object to where the object is displayed.

According to the technique, where the object is displayed (a relative position of the object and the background) can be changed as if the background is shifted by a finger while the object is actually being held by another finger. In other words, according to the technique disclosed in Patent Literature 1, where the object is displayed can be shifted on the background.

For example, general drawing software can be exemplified as a conventional technique of (i) copying a part of an image and pasting the part to another image or (ii) shifting the part of the image. The general drawing software is an interface for shifting or copying, to an image or another image, a part of the image which part is included in a region determined by, for example, being surrounded by a line.

### CITATION LIST

### Patent Literature

Patent Literature 1

Japanese Patent Application Publication, Tokukai No. 2010-86519 A (Publication Date: Apr. 15, 2010)

### SUMMARY OF INVENTION

### Technical Problem

The conventional interface has a problem that it is difficult to copy or shift an image included in a determined region.

Specifically, the conventional interface determines a region of an image to be copied, determines where the copied image is to be pasted, and then pastes the copied image. Upon pasting the copied image, the conventional interface displays the copied image in the determined region on where the copied image is to be pasted. It is therefore impossible to know how the copied image is to be displayed until the copied image is actually displayed, and there is a case where the copied image is not like as expected.

In a case where the conventional interface designates a region of a part of an image, which part is to be shifted (cut and pasted), the conventional interface can determine where the part is to be shifted (where the part is to be pasted) by dragging the region in the image. It is therefore possible to know, before the part is actually shifted, what image is obtained after shifting of the part.

However, according to the conventional interface, where a designated region can be dragged is limited to within the image, and therefore the designated region cannot be shifted to another image by being dragged. Further, in a case where the image is so large that the image cannot be displayed in one screen, it is necessary to drag the designated region while scrolling the image. That is, a complicated operation is required.

The technique of Patent Literature 1 is not a technique of (i) copying a part of an image and pasting the part on another image or (ii) shifting the part to the another image but a technique of changing where an object is displayed (a relative position of the object and a background). Therefore, the technique of Patent Literature 1 cannot solve the problem.

The present invention was made in view of the problem, and an object of the present invention is to provide, for example, an information processing device capable of easily copying or shifting, to another image, a part of an image which part is included in a designated region.

### Solution to Problem

In order to attain the object, an information processing device of the present invention is configured to be an information processing device for causing a display section to display an image which is changeable by page-based change, including: object display processing means for generating a selecting object and causing the display section to display the selecting object, the selecting object being generated on the basis of a partial image of an image displayed on the display section, which partial image is included in a region designated by a user operation, and the selecting object thus generated including the partial image and being for use to select, by shifting the selecting object on the image displayed on the display section, where the partial image is to be shifted or copied; and shifting or copying means for performing shifting or copying of the partial image in such a manner that, in a case where a user operation which determines a final destination of the selecting object thus shifted by the shifting is detected, the partial image on the basis of which the selecting object is generated is shifted or copied to the final destination of the selecting object thus shifted by the shifting, when a page of the image displayed on the display section is changed to another page, the object display processing means displaying the selecting object on the another page.

In order to attain the object, a method of the present invention for controlling an information processing device is configured to be a method for controlling an information processing device for causing a display section to display an image which is changeable by page-based change, including: an object display processing step of (i) generating a selecting object and causing the display section to display the selecting object, the selecting object being generated on the basis of a partial image of an image displayed on the display section, which partial image is included in a region designated by a user operation on the information processing device, and the selecting object thus generated including the partial image and being for use to select, by shifting the selecting object on the image displayed on the display section, where the partial image is to be shifted or copied; a step of, when a page of the image displayed on the display section is changed to another page, displaying, on the another page, the selecting object displayed by the object display processing step; and a shifting or copying step of performing shifting or copying of the partial image in such a manner that, in a case where the information processing device detects a user operation which determines a final destination of the selecting object thus shifted by the shifting, the partial image on the basis of which the selecting object is generated is shifted or copied to the final destination of the selecting object thus shifted by the shifting.

According to the configuration, an image is changeable by page-based change, and when a page of the image displayed on the display section is changed to another page, the selecting object is displayed on an image of the another page. Further, the selecting object can be shifted on the image of the another page, and includes the partial image included in the designated region.

This enables a user to carry out an operation of determining where the partial image is to be shifted or copied while recognizing an image obtained by (i) shifting the selecting object on an image whose page has been turned and (ii) determining the final destination of the selecting object thus shifted by the shifting.

That is, a user can copy or shift an image by (i) designating a region to be copied or shifted, (ii) finding a desired image by page-based change of the image, (iii) considering where the partial image is to shifted or copied by shifting the selecting object on the desired image thus found, and then (iv) determining, on the desired image, a desired destination to which the partial image is to be shifted or copied. In other words, a user can easily copy or shift, to another image, a part of an image, which part is included in a designated region.

### Advantageous Effects of Invention

An information processing device of the present invention is configured to include: object display processing means for generating a selecting object and causing the display section to display the selecting object, the selecting object being generated on the basis of a partial image of an image displayed on the display section, which partial image is included in a region designated by a user operation, and the selecting object thus generated including the partial image and being for use to select, by shifting the selecting object on the image displayed on the display section, where the partial image is to be shifted or copied; and shifting or copying means for performing shifting or copying of the partial image in such a manner that, in a case where a user operation which determines a final destination of the selecting object thus shifted by the shifting is detected, the partial image on the basis of which the selecting object is generated is shifted or copied to the final destination of the selecting object thus shifted by the shifting, when a page of the image displayed on the display section is changed to another page, the object display processing means displaying the selecting object on the another page.

A method of the present invention for controlling an information processing device includes: an object display processing step of (i) generating a selecting object and causing the display section to display the selecting object, the selecting object being generated on the basis of a partial image of an image displayed on the display section, which partial image is included in a region designated by a user operation on the information processing device, and the selecting object thus generated including the partial image and being for use to select, by shifting the selecting object on the image displayed on the display section, where the partial image is to be shifted or copied; a step of, when a page of the image displayed on the display section is changed to another page, displaying, on the another page, the selecting object displayed by the object display processing step; and a shifting or copying step of performing shifting or copying of the partial image in such a manner that, in a case where the information processing device detects a user operation which determines a final destination of the selecting object thus shifted by the shifting, the partial image on the basis of which the selecting object is generated is shifted or copied to the final destination of the selecting object thus shifted by the shifting.

Therefore, a user can copy or shift an image by (i) designating a region to be copied or shifted, (ii) finding a desired image by page-based change of the image, (iii) considering where the partial image is to shifted or copied by shifting the selecting object on the desired image thus found, and then (iv) determining, on the desired image, a desired destination to which the partial image is to be shifted or copied. That is, a user can easily copy or shift, to another image, a part of an image, which part is included in a designated region.

For a fuller understanding of the nature and advantages of the invention, reference should be made to the ensuing detailed description taken in conjunction with the accompanying drawings.

### BRIEF DESCRIPTION OF DRAWINGS

FIG. 1 is a block diagram illustrating an example configuration of an electronic notebook device in accordance with an embodiment of the present invention.

FIG. 2 is a view exemplifying a data structure of electronic notebook information.

FIG. 3 is a view exemplifying a data structure of display page managing information.

FIG. 4 is a view exemplifying a data structure of shift and copy managing information.

FIG. 5 is a view exemplifying page information displayed on page 1 of an electronic notebook.

FIG. 6 is a view exemplifying page information displayed on page 2 of the electronic notebook.

FIG. 7 is a view exemplifying an appearance of a tool box in which editing tools of the electronic notebook are collected.

FIG. 8 is a view specifically illustrating how to copy an image. (a) through (h) of FIG. 8 exemplify how to copy the image on a page onto another page.

FIG. 9 is an explanatory view for describing how to obtain a selecting object by separating overlapped characters. (a) of FIG. 9 illustrates a state in which a character is surrounded. (b) of FIG. 9 illustrates a state in which the character thus surrounded is separated from the other character.

FIG. 10 is a flowchart exemplifying processes executed by the electronic notebook device.

FIG. 11 is a view specifically illustrating an example of how to copy in a case of page division. (a) through (i) of FIG. 11 exemplify a case where the page is divided and then an image on a page is copied on another page.

FIG. 12 is a view illustrating another example of how to copy n a case of page division. (a) through (d) of FIG. 12 exemplify a case where the page is divided and then a selected region which extends over divided pages is designated.

FIG. 13 is a flowchart exemplifying processes executed by the electronic notebook device in a case of page division.

FIG. 14 is a flowchart exemplifying a page dividing process executed by the electronic notebook device.

### DESCRIPTION OF EMBODIMENTS

(Outline of Electronic Notebook Device)

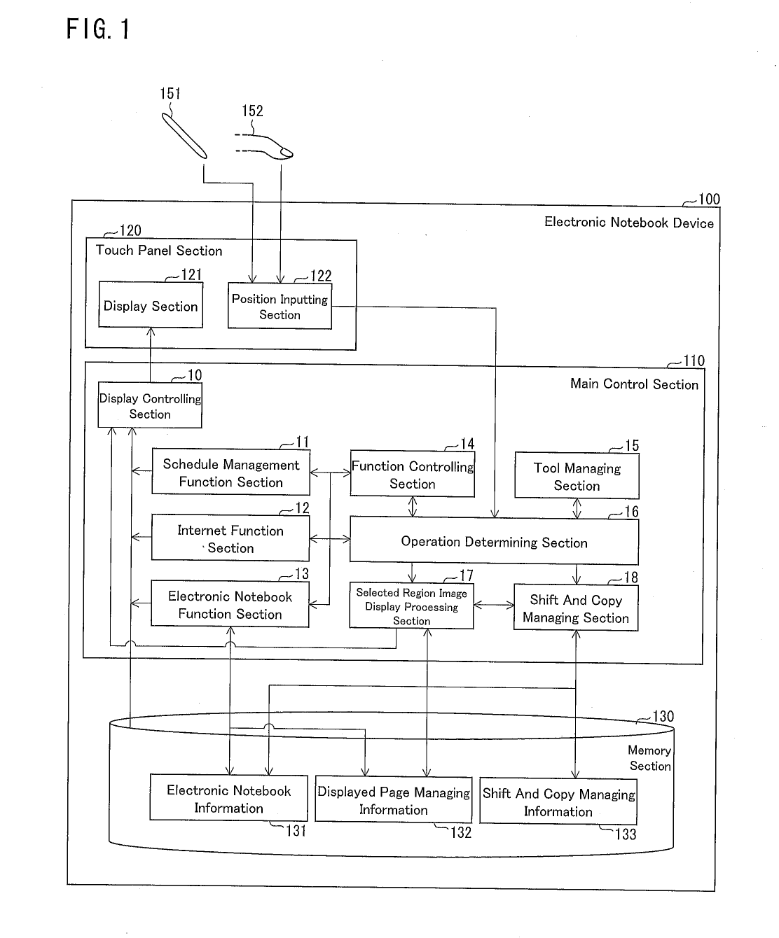

One embodiment of the present invention is described below with reference to FIGS. 1 through 14.

First, an outline of functions of an electronic notebook device (information processing device) 100 in accordance with the present embodiment is described with reference to FIG. 1. FIG. 1 is a block diagram illustrating an example configuration of the electronic notebook device 100.

The electronic notebook device 100 is a device for providing (i) a function which enables a user to edit, b y a handwriting input of the user, a notebook realized on software and (ii) other information processing functions. Hereinafter, a notebook realized on software is referred to as an electronic notebook.

As illustrated in FIG. 1, the electronic notebook device 100 includes a touch panel section 120, a memory section 130, and a main control section 110.

The touch panel section 120 (i) provides a user interface for receiving an input to the electronic notebook device 100 and displaying a screen of the electronic notebook device 100, and (ii) includes a display section 121 and a position inputting section (touch panel) 122.

The position inputting section 122 (i) detects a touch position that is a position of a part of an operation screen of the touch panel section 120, to which part a touch operation is carried out and (ii) generates input position information on the touch position.

Here, the touch operation indicates an operation of touching the operation screen by use of an instruction member such as a touch pen 151 or a finger 152 of a user. Further, the touch position indicates a position, detected by the position inputting section 122, of where the touch pen 151 or the finger 152 touches the operation screen.

Moreover, the position inputting section 122 can be realized by, for example, a touch panel. Here, an electrostatic capacitance method is employed as an example of a method by which the position inputting section 122 detects a touch position. However, the method is not limited to the electrostatic capacitance method. Various methods such as a matrix switch method, a resistive film method, a surface elastic wave method, an infrared method, an electromagnetic induction method, an electrostatic capacitance method, and a method for detecting an image of an object (an optical sensor method) can be appropriately employed.

The position inputting section 122 is configured, as an example, to detect a plurality of touch positions simultaneously. However, the configuration of the position inputting section 122 is not limited to the example. The position inputting section 122 can be configured to detect a single touch position only.

The position inputting section 122 can detects such that a touch operation by the touch pen 151 is distinguished from a touch operation by the finger 152. Such detection can be achieved by, for example, configuring the position inputting section 122 as below.

That is, the position inputting section 122 (i) detects a region touched by the touch pen 151 or the finger 152, and (ii) calculates an area of the region thus detected. The position inputting section 122 determines that the touch operation is carried out by the finger 152, in a case where the area of the region thus calculated is larger than a predetermined area. In contrast, the position inputting section 122 determines that the touch operation is carried out by the touch pen 151, in a case where the area of the region thus calculated is smaller than the predetermined area.

Alternatively, an operation by the touch pen 151 can be distinguished from an operation by the finger 152 by use of different mechanisms, one of which recognizes a touch by the touch pen, and the other of which recognizes a touch by the finger. For example, an operation carried out by a touch pen 151 having a pen tablet function (a touch pen employing an electromagnetic induction method) is detected, while an operation carried out by the finger 152 is detected by an electrostatic capacitance method. Needless to say, a method for distinguishing the operation by the touch pen 151 from the operation by the finger 152 is not limited to the above example. Any methods for distinguishing a touch by the touch pen from a touch by the finger can be employed.

The position inputting section 122 may generate input position information which contains classification indicative of whether a touch operation is carried out by the touch pen 151 or by the finger 152.

Further, the position inputting section 122 can detect a state in which a tip of the touch pen 151 is not in contact with the operation screen of the touch panel section 120 but is kept close to the operation screen via a minute distance from the operation screen, that is, a hovering state.

The position inputting section 122 may generate input position information that is two-dimensional coordinate data indicative of a touch position on the operation screen. Alternatively, the position inputting section 122 may detect a pressure of a touch operation and generate input position information containing information on the pressure thus

detected. The display section 121 includes a display screen on which image data is displayed. The display section 121 receives image data supplied from the main control section 110, and displays, on the display screen, an image based on the image data thus received. The display section 121 can be realized by, for example, an LCD (Liquid Crystal Display), a PDP (Plasma Display Panel), an EL (Electroluminescence) display, or an electronic paper.

The position inputting section 122 discussed herein is, as an example, integrated with the display section 121 on the display screen of the display section 121 in such a manner that coordinates of the display screen correspond respectively to those of the operation screen. It may be arranged such that information on the basis of which the coordinates of the display screen correspond respectively to those of the operation screen is stored in the memory section 130.

Further, a part of the position inputting section 122, which part faces the display screen, is made from a material which is transmissive to light so that display on the display screen of the display section 121 is not blocked.

The above-mentioned configuration enables a user to carry out an input operation to the operation screen while confirming the screen displayed on the display section 121. A specific example of the screen displayed on the display section 121 is a GUI (Graphical User Interface) (such as an icon) screen. The position inputting section 122 generates coordinate information on a coordinate of an icon or an image on the operation screen of the position inputting section 122, which icon or image is touched by a user's finger (or a touch pen).

The above has described an example configuration of the touch panel section 120. However, the configuration of the touch panel section 120 is not limited to the example configuration. Any configurations can be employed as long as the display screen and the operation screen are used in common. Further, the above-mentioned touch panel input method is desirable because an intuitive operation can be carried out. However, an input method of the present embodiment is not limited to the above-mentioned touch panel input method. The input method can be a method of carrying out an input operation by use of other input device such as a button, a key, or a mouse.

The memory section 130 is a section for storing various data and programs. The memory section 130 can be constituted by, for example, a hard disk, a flash memory, a ROM (Read Only Memory), or a RAM (Random Access Memory). Details of the memory section 130 are described later.

The main control section 110 is a section for collectively controlling various configurations in the electronic notebook device 100. Functions of the main control section 110 are achieved by a CPU (Central Processing Unit) for executing a program stored in a memory cell such as an RAM or a flash memory.

(Specific configurations of Memory Section and Main Control Section)

The following more specifically describes each configuration of the memory section 130 and the main control section 110.

First, the configuration of the memory section 130 is described. As illustrated in FIG. 1, the memory section 130 stores electronic notebook information 131, display page managing information 132, and shift and copy managing information 133.

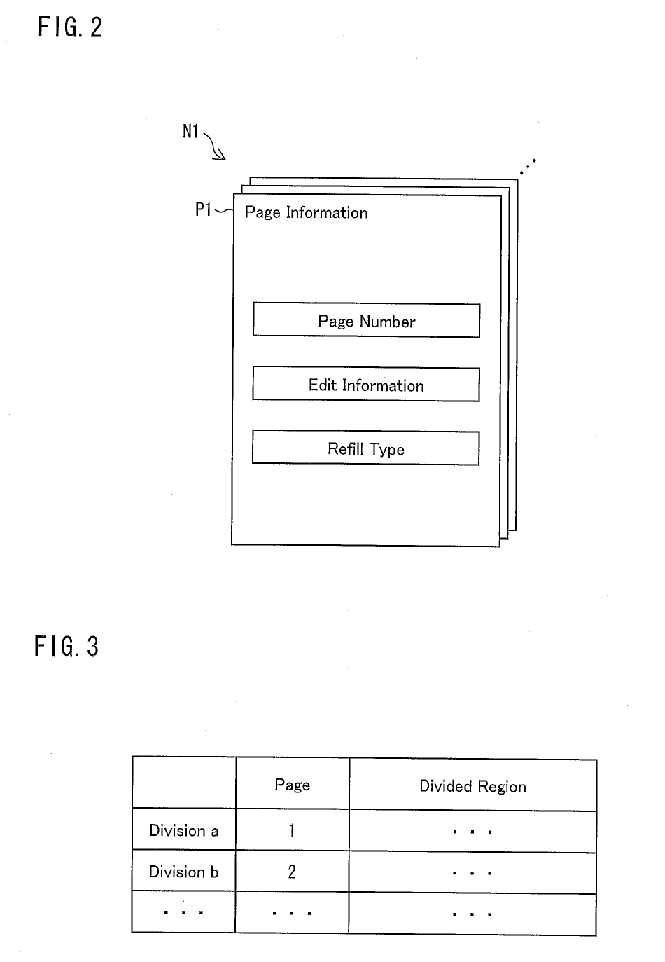

The electronic notebook information 131 includes electronic notebook information. A data structure of the electronic notebook information is described as below with reference to FIG. 2. FIG. 2 is a view exemplifying the data structure of the electronic notebook information.

As illustrated in FIG. 2, electronic notebook information N1 includes page information P1 which is electronic information on each page of an electronic notebook. The page information P1 includes pieces of data of a “page number”, “edit information”, and a “refill type”.

The “page number” indicates a page number assigned to a page. The “edit information” is a data region which can be freely edited on the touch panel section 120 by user's handwriting. A method based on a digital ink method or a bitmap method can be employed as a data format of the “edit information”.

In the “refill type”, types of refill, which is set for each page, is set. Here, the types of refill indicate a sheet pattern such as ruled lines ruled on a paper notebook. The sheet pattern is displayed by, for example, displaying, under a sheet, a background image which shows e.g., ruled lines. Examples of the types of refill include (i) horizontal lines such as 7 mm-horizontal lines or 6 mm-horizontal lines with dots, (ii) 5 mm grid, (iii) plain, and (iv) a format for minutes.

The following describes the display page managing information 132. The display page managing information 132 is management information which is used for displaying a page of the electronic notebook. The electronic notebook device 100 is configured to divide a page of the electronic notebook into a plurality of pages and to display, on a screen, images on the plurality of respective pages. The display page managing information 132 includes information which enables such display.

The display page managing information 132 may be, for example, data illustrated in FIG. 3. FIG. 3 is a diagram exemplifying a data structure of the display page managing information 132. The display page managing information 132 illustrated in FIG. 3 includes (i) identification information of each divided region (“division a” and “division b”), (ii) page information indicative o f a page to which the each divided region belongs, and (iii) information indicative of a range of the each divided region, which are associated with one another.

That is, FIG. 3 illustrates an example in which a screen is divided into two regions, “division a” and “division b”, and page 1 is assigned to the “division a” and page 2 is assigned to the “division b”. Further, in the example, the “division a” occupies a range indicated in a corresponding “divided region” column, and similarly, the “division b” occupies a range indicated in a corresponding “divided region” column. The “divided region” column is not limited to have a specific information form as long as the “divided region” column includes information indicative of a range which each divided region occupies on the display screen. For example, a range of each divided region may be indicated by coordinates on the display screen.

By referring to the display page managing information 132, the images on the plurality of respective pages can be simultaneously displayed on a screen. In a case where no page division is carried out, only information indicating that the page of the “division a” is stored in the display page managing information 132. When a division is carried out, the display page managing information 132 is updated so as to store (i) information indicative of the page of the “division b”, (ii) information indicative of the “divided region” of the “division a”, and (iii) information indicative of the “divided region” of the “division b”. Similarly, a page can be divided into three or more pages.

The following describes the shift and copy managing information 133. The shift and copy managing information 133 is management information which is used for (i) controlling where a selecting object is displayed and (ii) shifting and copying an image. The electronic notebook device 100 is configured to (i) display a selecting object which is generated on the basis of an image which is included in a region which is designated on the display screen and (ii) designate where the image is to be shifted or copied by shifting the selecting object. The shift and copy managing information 133 includes information which enables such a process.

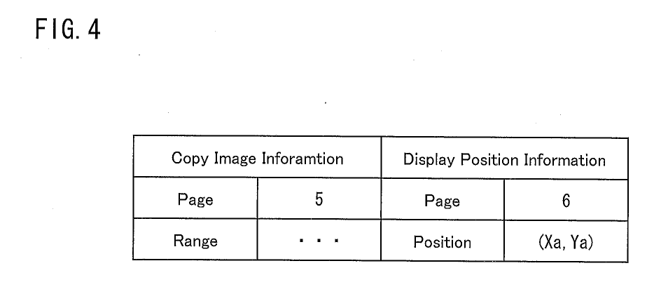

The shift and copy managing information 133 may be, for example, data illustrated in FIG. 4. FIG. 4 is a diagram exemplifying a data structure of the shift and copy managing information 133. The shift and copy managing information 133 illustrated in FIG. 4 includes (i) copy image information which is used for identifying data which is to be shifted or copied and (ii) display position information which is used for identifying where a selecting object is to be displayed.

Specifically, the copy image information includes (i) a “page” (page identifying information) indicative of a page, in the electronic notebook, which is assigned to an image which is to be copied and (ii) information indicative of a range, in the page, which is occupied by the image (where the image is on the page). T he copy image information is not limited to the example as long as the copy image information is indicative of (i) an image which is to be copied and (ii) a part of the image, which part is to be copied or shifted.

The display position information includes (i) a “page” indicative of a page, in the electronic notebook, which displays the selecting object and (ii) a “position” indicative of where the selecting object is to be displayed on the page.

The display position information is not limited to the example as long as the display position information is indicative of a page on which the selecting object is to be displayed and where the selecting object is to be displayed on the page.

FIG. 4 illustrates an example in which (i) an image in a region indicated by a “range” on page 5 is an image which is to be copied (or an image which is to be shifted) and (ii) a selecting object generated on the basis of the image in the region is to be displayed at a position (Xa, Ya) on page 6.

That is, the selecting object can be freely shifted not only in an identical page but also to a different page until where the image is to be shifted or copied is determined. This is achieved by updating the display position information.

The following describes the main control section 110 with reference to FIG. 1. As described in FIG. 1, the main control section 110 includes a display controlling section 10, a schedule management function section 11, an internet function section 12, an electronic notebook function section (region division controlling means) 13, a function controlling section 14, a tool managing section 15, a n operation determining section 16, a selected region image display processing section (object display processing means) 17, and a shift and copy managing section (shifting or copying means, page identifying information recording means, image correspondence determining means) 18.

The display controlling section 10 controls the display section 121 to display an image, according to an instruction from the schedule management function section 11, the internet function section 12, the electronic notebook function section 13, the selected region image display processing section 17, the shift and copy managing section 18, or like section.

The schedule management function section 11 provides a schedule management function of editing and managing a schedule. The internet function section 12 provides an internet function of communicating with the Internet v is a communication section (not shown) for communicating with an external network. The electronic notebook function section 13 provides an electronic notebook function of editing and browsing the electronic notebook.

That is, the schedule management function section 11, the internet function section 12, the electronic notebook function section 13 provide main functions of the electronic notebook device 100, that is, provides the schedule management function, the internet function, and the electronic notebook function, respectively. The functions may be originally included in the electronic notebook device 100, or can be added by installation of applications. In a case where the functions are realized by installing applications, the functions can be deleted by uninstalling the applications.

The function controlling section 14 executes and controls the electronic notebook function, the schedule management function, and the internet function. Specifically, the function controlling section 14 causes one or more of the schedule management function section 11, the internet function section 12, and the electronic notebook function section 13 t o function. That is, with the function controlling section 14 as such, it is possible for a user to use merely one of the electronic notebook function, the schedule management function, and the internet function by the function controlling section 14 controlling a corresponding one of the electronic notebook function section 13, the schedule management function section 11, and the internet function section 12 to function, and it is also possible for a user to use simultaneously two or more of the electronic notebook function, the schedule management function, and the internet function by the function controlling section 14 controlling corresponding ones of the electronic notebook function section 13, the schedule management function section 11, and the internet function section 12 to simultaneously function.

The tool managing section 15 manages various tools which are used for editing of the electronic notebook. An input operation carried out by a user is interpreted in accordance with a tool enabled by the tool managing section 15. For example, in a case where a line is drawn on the position inputting section 122 while the tool managing section 15 is enabling a pen tool for inputting characters, the line thus drawn is interpreted as a drawn line. Meanwhile, in a case where a line is drawn on the position inputting section 122 while the tool managing section 15 is enabling a tool for partially erasing an image (an eraser tool), the line thus drawn is interpreted as a part to be erased.

The operation determining section 16 recognizes, on the basis of input position information supplied from the position inputting section 122 of the touch panel section 120, a touch operation or a gesture carried out by a user to the touch panel section 120.

The operation determining section 16 recognizes, as a gesture, a touch operation carried out by use of the finger 152, but does not recognize, as a gesture, a touch operation carried out by use of the touch pen 151. Whether or not a touch operation is recognized as a gesture is determined on the basis of an after-mentioned pattern. This makes it possible to prevent, for example, handwriting input with the use of the touch pen 151 from being unintendedly recognized as a gesture. It is therefore possible to prevent execution of an operation which is unintended by a user. Note that the operation determining section 16 can be configured to recognize, as a gesture, a touch operation carried out by use of the touch pen 151.

Further, the operation determining section 16 determines an operation carried out by a user, on the basis of, for example, (i) whether the operation is carried out by the user by use of the touch pen 151 or by use of the finger 152, (ii) a function section which is caused to function by the function controlling section 14, and (iii) a tool which is enabled by the tool managing section 15. The operation determining section 16 transmits, to, for example, the schedule management function section 11, control information based on a result of the determination. This allows the main control section 110 to carry out a process in accordance with a user operation.

Here, the gesture indicates a touch operation carried out according to a predetermined pattern. The operation determining section 16 recognizes, for example, a single touch, a double touch, a drag, and a flick as a gesture.

The single touch is a gesture indicative of a touch operation of (i) touching the touch panel section 120 by use of, for example, the finger 152 and then (ii) immediately moving the finger 152 away from the touch panel section 120. The double touch is a gesture of carrying out successive two single touches to the touch panel section 120 for a predetermined short period of time. The drag is a gesture of sliding, for example, the finger 152 on the touch panel section 120 with the finger 152 in contact with the touch panel section 120. The flick is a gesture indicative of a touch operation of (i) sliding, for example, the finger 152 on the touch panel section 120 with the finger 152 in contact with the touch panel section 120 and then (ii) moving the finger 152 away from the touch panel section 120 within a predetermined short period of time. That is, the flick is an action of lightly flipping the touch panel section 120.

The selected region image display processing section 17 controls display of a selecting object which is used for selecting where an image is to be shifted or copied. Specifically, the selected region image display processing section 17 obtains, from the edit information (see FIG. 2) of the page information stored in the memory section 130, an image in a region which is designated by a user as a region to be shifted or copied. Then, the selected region image display processing section 17 processes the image in the region and generates a selecting object so that the user can recognize that the image in the region is selected as an image to be shifted or copied. The image in the region thus designated can be used as the selecting object as it is without being processed. From the viewpoint of user's operability, however, it is preferable to process the image in the region so that the image to be copied or shifted is distinguishable from the other part of an image which includes the region.

The selecting object can be shifted on the display screen. This makes it possible to decide where the image in the region is to be shifted or copied by shifting the selecting object on the display screen. In a case where a page on which the selecting object is displayed is changed to another page, the selected region image display processing section 17 displays the selecting object on the another page. This makes it possible to easily carry out a copy or shift to a desired page.

The shift and copy managing section 18 updates the shift and copy managing information 133 which is used for (i) display control of the selecting object and (ii) copy or shift of the image on the base of which the selecting object is generated, so as to change where the selecting object is displayed or so as to copy or shift the image.

(Summary of Electronic Notebook Function)

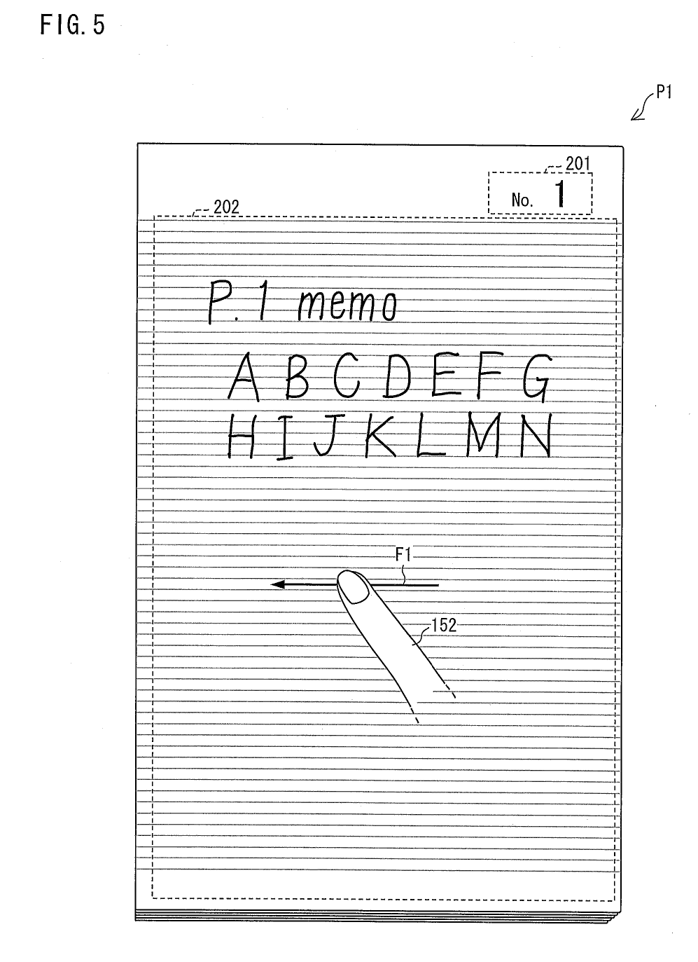

The following description will schematically discuss, with reference to FIGS. 5 through 7, an electronic notebook function achieved by the electronic notebook function section 13.

First, an appearance of an electronic notebook displayed by the display section 12 of the touch panel section 120 will be described below with reference to FIG. 5. FIG. 5 exemplifies page information P1 displayed on page 1 of the electronic notebook.

Specifically, FIG. 5 illustrates an example in which (i) the “page number” of the page information P1 is set to “1”, (ii) the “refill type” of the page information P1 is set to “horizontal lines”, and (iii) “P. 1 memo ABCDEFGHIJKLMN” is handwritten as the “edit information” of the page information P 1.

As illustrated in FIG. 5, a display region of the electronic notebook contains (i) a page number region 201 in which the “page number” of the page information P1 is displayed and (ii) an edit region 202 in which the “edit information” is displayed. In the page number region 201 illustrated in FIG. 3, “1” which is the “page number” of the page information P1 is displayed. In the page number region 201, “P. 1 memo ABCDEFGHIJKLMN”, which is the “edit information”, is displayed.

The left side of the page information P1 illustrated in FIG. 5 corresponds to an inside edge of a paper notebook. In other words, the left side of FIG. 5 corresponds to a center part of two facing pages of the paper notebook, that is, the bound side of the paper notebook. On the other hand, a right side of the page information P1 illustrated in FIG. 5 corresponds to an outside of the paper notebook, that is, an edge (an edge facing the inside edge) of the paper notebook.

However, the configuration is merely an example. T he electronic notebook can be configured as if the electronic notebook were a paper notebook whose pages are turned in an up-and-down direction.

In a case where the touch pen 151 touches the position inputting section 122 while (i) the function controlling section 14 is causing the electronic notebook function section 13 to function and (ii) the tool managing section 15 is selecting a pen tool which is a tool for inputting characters, the operation determining section 16 determines, as handwriting, the touch made by the touch pen 151. Then, the operation determining section 16 transmits, to the electronic notebook function section 13, data (e.g., coordinates) that indicates a line drawn through the touch made by the touch pen 151.

The electronic notebook function section 13 adds a line having a color and a width of the pen tool to edit information of a page on the basis of the data transmitted by the operation determining section 16, so that page information is updated. Then, the electronic notebook function section 13 instructs the display controlling section 10 to cause the display section 121 to carry out display based on the edit information thus updated. By carrying out such processes, handwriting input is achieved on the electronic notebook.

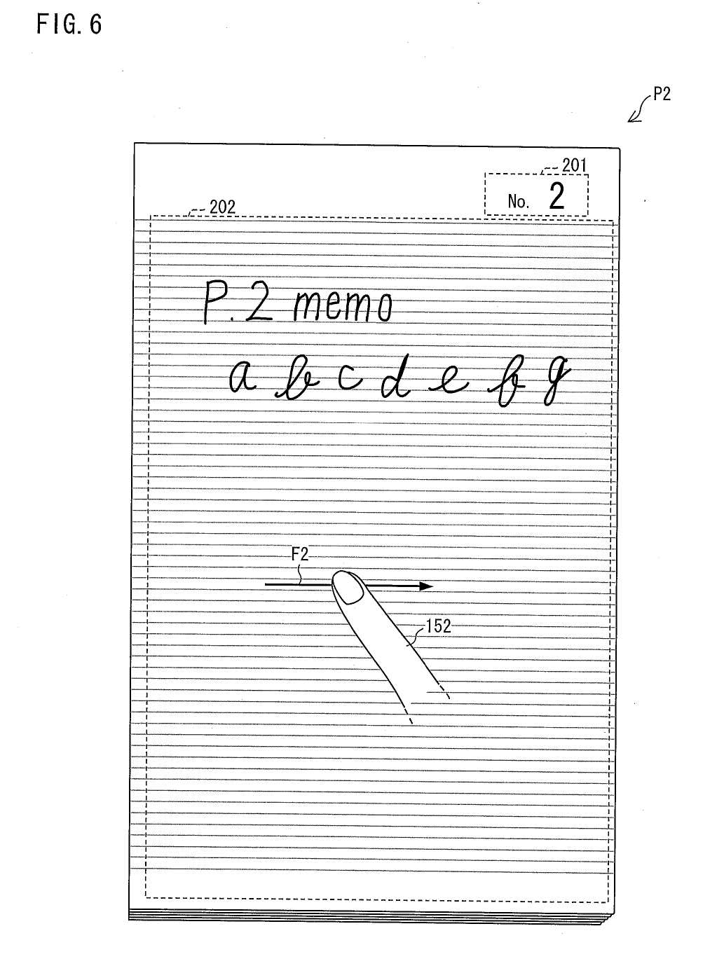

The following description will discuss, with reference to FIGS. 5 and 6, how the electronic notebook function section 13 achieves a function of turning pages of the electronic notebook. FIG. 6 exemplifies page information P2 displayed on page 2 of the electronic notebook.

As illustrated in FIGS. 5 and 6, in a case where the operation determining section 16 detects a page turning gesture made by a touch operation of the finger 152 (e.g., a flick in a rightward or leftward direction horizontal to the display screen) while the page of the electronic notebook is being displayed, the operation determining section 16 transmits, to the electronic notebook function section 13, gesture information indicative of the page turning gesture (e.g., information indicating that the display screen was flicked in the leftward direction horizontal to the display screen).

The electronic notebook function section 13 receives the gesture information, and executes a process according to the gesture information. Note here that it is assumed that (i) the flick in the rightward direction horizontal to the display screen is to instruct a process of turning back a page and (ii) the flick in the leftward direction horizontal to the display screen is to instruct a process of turning a page to a next page.

Therefore, for example, in a case where the electronic notebook function section 13 receives the gesture information indicating that the display screen is flicked in the leftward direction, the electronic notebook function section 13 (i) reads out, from the electronic notebook information 131, page information on a page next to a currently displayed page, and (ii) instructs the display controlling section 10 to cause the display section 12 to display the page information on the next page.

Specifically, in a case where page 1 is turned by flicking page 1 in a direction indicated by a n arrow F1 (a leftward flick) illustrated in FIG. 5, a state in which page 1 is being turned is displayed, and then the page information P2 of page 2 is displayed on the display section 121 as illustrated in FIG. 6. The displaying is executed by the electronic notebook function section 13 reading out the page information P2 of page 2. More specifically, “P. 2 memo abcdefg” which is edit information of the page information P2 is displayed.

In contrast, in a case where page 2 which is displaying the page information P2 is flicked in a direction indicated by an arrow F2 (a rightward flick), the page information P1 of page 1 illustrated in FIG. 5 is displayed on the display section 12. The displaying is executed by the electronic notebook function section 13 reading out the page information P1 of page 1.

The electronic notebook function section 13 can be configured to carry out no operation even in a case where the electronic notebook function section 13 detects a rightward flick on the first page (i.e., page 1) which is being displayed. Further, the electronic notebook function section 142 can be configured to create a new page and turn the last page to the new page in a case where the electronic notebook function section 13 detects a leftward flick on the last page which is being displayed.

Moreover, t he electronic notebook function section 13 can be configured to, in a case where the display screen is divided into two display regions, instruct the display controlling section 10 to cause the display section 121 to (i) display page information of a page in one of the two display regions and (ii) display page information of another page in the other of the two display regions. Page division will be described in detail later.

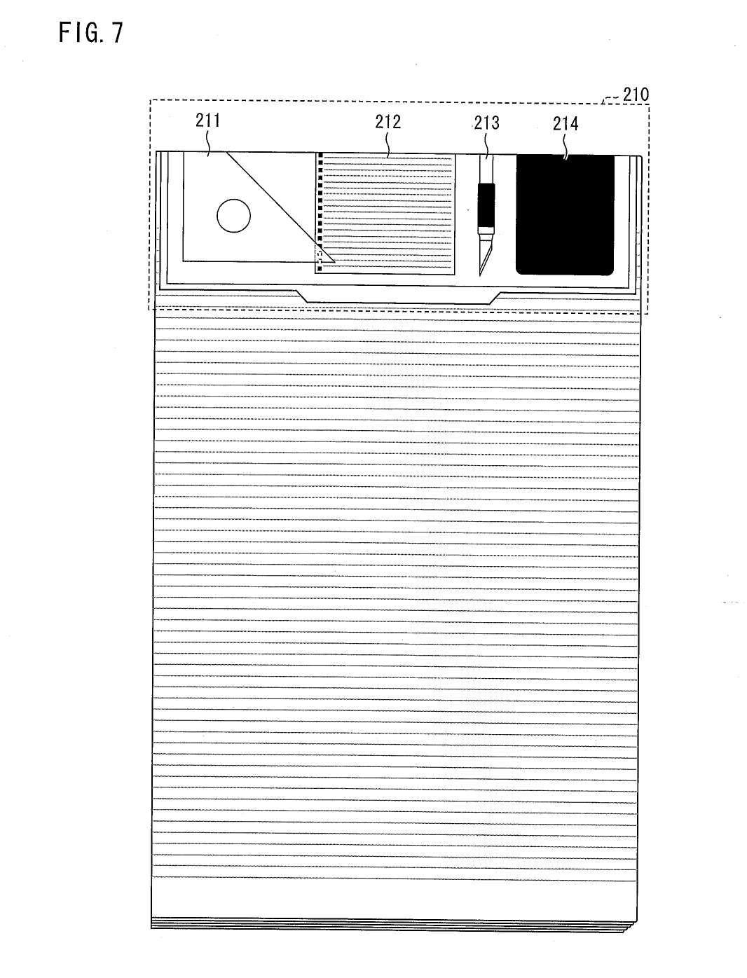

The following describes tools managed by the tool managing section 15 with reference to FIG. 7. When editing the electronic notebook, a user can use a tool box 210 in which various edit tools are collected (see FIG. 7). The tool box 210 can be displayed on the display screen by a user operation to the touch panel section 120, if necessary.

The tool box 210 stores tools (electronic stationery) to be used in an in-use application. In an example illustrated in FIG. 7, the tool box 210 stores a ruler 211, a refill 212, an art knife 213, and a pen case 214.

The ruler 211 is a tool for drawing figures such as a straight line and a circular shape in the edit region 202. The ruler 211 can be displayed in the edit region 202 by a user operation of selecting the ruler 211 with the use of the touch pen 151 or the finger 152. A user can draw a straight line along a contour of the ruler 211 by handwriting a line along the contour of the ruler 211. Further, a user can draw a circle by handwriting a line along a circular part of the ruler 211.

The refill 212 is a tool for adding or deleting a page. In a case where a user selects the refill 212 by use of the touch pen 151 or the finger 152, the electronic notebook function section 13 instructs the display controlling section 10 to cause the display section 121 to display addable types of refill so that the user can select a type of refill. The electronic notebook function section 13 then generates page information of the type of refill thus selected, and adds the page information to the electronic notebook information 131.

In a case where the refill 212 is selected by use of the touch pen 151 or the finger 152, and then a predetermined gesture (e.g., a rightward flick) is carried out, page information of a currently displayed page is deleted from the electronic notebook information 131. Note that in a case where a page that is neither the first page nor the last page is deleted, the page number of a page next to the deleted page is moved up accordingly.

The art knife 213 is a tool for designating a region to be copied or shifted. In a case where (i) the art knife 213 is selected by use of the touch pen 151 or the finger 152 and then (ii) a region on the display screen is surrounded by use of the touch pen 151, a selecting object is generated on the basis of an image which is included in the surrounded region (selected region), and displayed on the display screen. By dragging the selecting object by use of the touch pen 151 or the finger 152, the selecting object can be shifted on the display screen. Further, in a case where a page on which the selecting object is displayed is turned to another page, the selecting object is automatically shifted to the another page.

The image on the basis of which the selecting object is generated can be copied or shifted to where is determined as below. The copying or shifting of the image is performed by (i) shifting the selecting object to where the image is to be copied or shifted and (ii) determining where the image is to be copied or shifted. The determining is performed by touching the selecting object by use of the touch pen 151 or the finger 152.

Specifically, the image in the selected region is shifted in a case where where the image is to be copied or shifted is determined on a page where the selecting object has been generated, and in contrast, the image in the selected region is copied in a case where where the image is to be copied or shifted is determined on a page other than the page where the selecting object has been generated. Note, however, that whether the image is shifted or copied is not limited to the above example. The image in the selected region may be copied or shifted in the cases. Alternatively, whether the image is copied or shifted may be selected by a user. Such processes, which will be described in detail, can be realized by the selected region image display processing section 17 and the shift and copy managing section 18.

The art knife 213 is also used for determining where a page is divided. In a case where a line is drawn by the art knife 213 so as to reach an edge(s) of a page, the page is divided. In contrast, in a case where a line is drawn so as to surround a region on a page without reaching any edge(s) of the page, the region thus surrounded is to be copied or shifted.

The pen case 214 is a tool for handwriting an image on the electronic notebook. A user can select, from the pen case 214, desired types of pen such as width and/or color of a pen, and can handwrite an image by use of the pen.

The electronic notebook function section 13 can be configured such that the pen tool of the pen case 214 has been already selected when the electronic notebook is started up. The electronic notebook is started up by a function changing operation. The pen case 214 includes an eraser tool (not illustrated) for erasing edit information which has been handwritten.

(Specific Example of How to Copy Image)

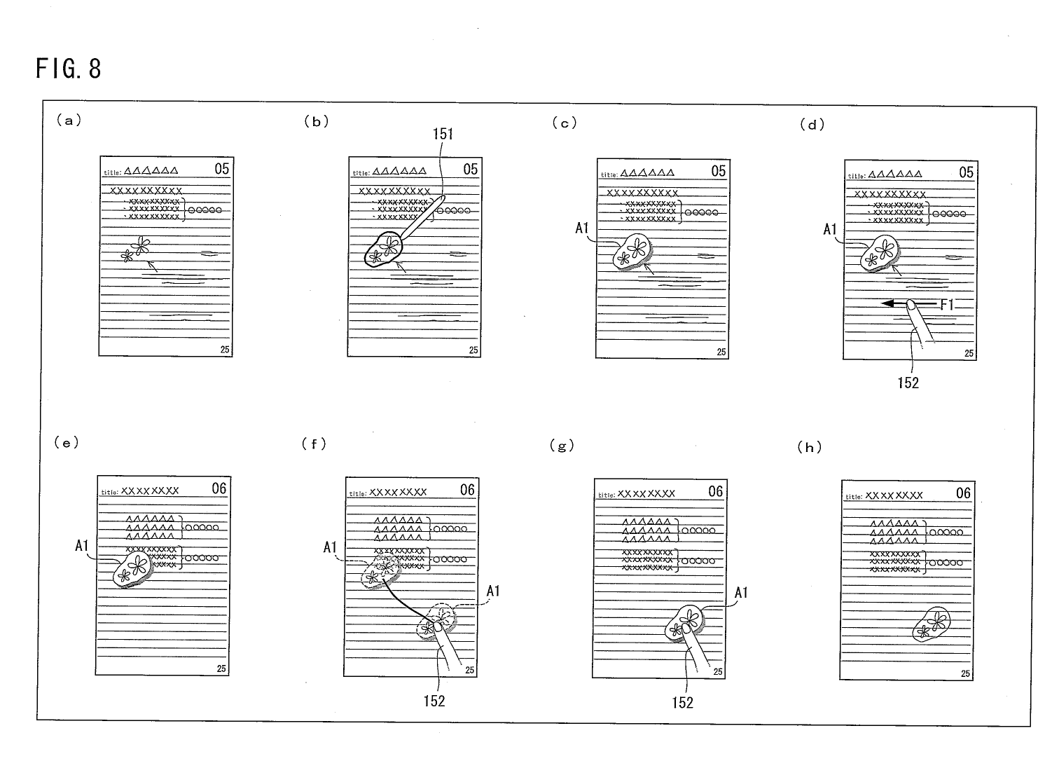

The following specifically describes an example of how to copy an image with reference to FIG. 8. (a) through (h) of FIG. 8 exemplify how to copy an image on a page to another page.

(a) of FIG. 8 illustrates a page (page 5) including an image to be copied. A region to be copied is surrounded by use of the touch pen 151 (see (b) of FIG. 8) while the art knife 213 is being selected. It is preferable that, as illustrated in (b) of FIG. 8, a line drawn by the touch pen 151 be displayed so as to be visible to a user. This enables the user to recognize where the line is drawn.

In a case where the line drawn by the touch pen 151 is a closed region, a selecting object A1 generated on the basis of the image in the closed region is displayed as illustrated in (c) of FIG. 8. Specifically, (c) of FIG. 8 illustrates the selecting object A1 showing a state where the image in the closed region is floating up from the display screen as if the image in the closed region were actually cut from the display screen. The selecting object A1 can be generated by, for example, (i) reading out, from the electronic notebook information 131, the image in the closed region, and (ii) performing a process o f shading an outer periphery of the image.

The next page (i.e., page 6) can be displayed by flicking page 5, on which the selecting object A1 is displayed, by use of the finger 152 in a direction indicated by an arrow F1 as illustrated in (d) of FIG. 8. (e) of FIG. 8 illustrates the next page. In (e) of FIG. 8, page 5 has been already turned to page 6, and the selecting object A1 is displayed on page 6.

(e) of FIG. 8 illustrates an example in which where the selecting object A1 is displayed is not different from on page 5 to on page 6. In other words, where the selecting object Al is displayed in (e) of FIG. 8 is the same as where the selecting object A1 is displayed in (d) of FIG. 8. However, where the selecting object A1 is displayed may be changed after a page turning operation. For example, where the selecting object A1 is displayed may be a predetermined position (such as top left, top right, or center) on the display screen. Alternatively, a blank part of the display screen, on which blank part no image is drawn, is detected, and the selecting object A1 may be displayed on the blank page. This is because it is considered that a blank part is highly likely to be selected as where the image is to be copied or shifted.

The selecting object A1 can be shifted on the same display screen by being dragged as illustrated in (f) of FIG. 8. A destination of the selecting object A1 thus shifted can be determined by (i) shifting the selecting object A1 to a desired position on the display screen and (ii) touching the selecting object A1 as illustrated in (g) of FIG. 8.

When the destination is determined, the display screen displays an animation in which the selecting object A1 sinks into the display screen (e.g., an animation in which the shade of the selecting object A1 disappears). As illustrated in (h) of FIG. 8, the display screen then displays an image which is obtained by copying the image in the closed region illustrated in (b) of FIG. 8 onto the destination. Note here that since the image cut from page 5 is shifted to page 6, the image is copied. In other words, display on page 5 is not changed but only display on page 6 is changed.

Thus, the electronic notebook device 100 can copy an image by performing an intuitive operation as if a document were actually cut and pasted. Further, the electronic notebook device 100 can shift an image by, through the same intuitive operation, shifting the selecting object A1 on the same page (page 5) and determining where the image is to be shifted.

(Region Designation)

Region designation is carried out by surrounding, for example, a handwritten character b y use of the touch pen 151. In particular, in a case where a plurality of handwritten characters overlap with each other, it would be difficult to surround only a desired character.

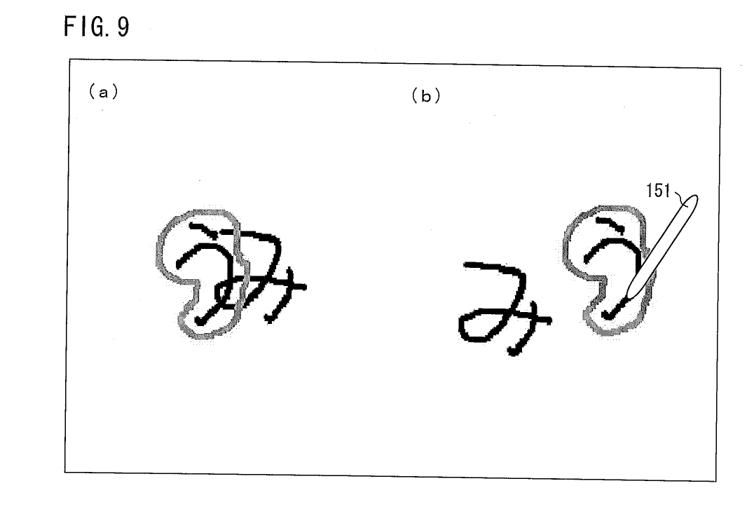

In the case, a character is recognized in a surrounded region so that the character is separated from overlapped characters, and the character may be used as a selecting object. This is described below with reference to FIG. 9. FIG. 9 is an explanatory view for describing how to obtain a selecting object by separating overlapped characters. (a) of FIG. 9 illustrates a state in which a character is surrounded. (b) of FIG. 9 illustrates a state in which the character thus surrounded is separated from the other character.

As illustrated in (a) of FIG. 9, it is assumed that a word “ [symbol] ” is handwritten, and a character “ [symbol] ” is surrounded. In the work “ [symbol] ”, the character “ [symbol] ” and a character “ [symbol] ” overlap with each other, so that an surrounded region includeds a part of the character “ [symbol] ”.

In a case where such region destination is carried out, a handwritten line which is not protruding from a designated region may be determined as a subject to be copied or shifted. Note that such determination is carried out in a case where a data format of “edit information” i s a digital ink method. This makes it possible to copy or shift the character “ [symbol] ” only as illustrated in (b) of FIG. 9.

Alternatively, in a case where the data format of the “edit information” is a bitmap method, a bitmapped image in which handwritten characters are in respective layers is recorded, and a layer in which no handwritten character is protruding from a designated region may be determined as a subject to be copied or shifted. This makes it possible to copy or shift the character “ [symbol] ” only as illustrated in (b) of FIG. 9.

In the case where the data format of the “edit information” is the bitmap method, a single bitmapped image is recorded in a handwriting notebook, a character in a designated region is recognized by means of, for example, pattern matching, and a line which is not recognized a s a character may be deleted from the designated region.

When a location of a selecting object which is obtained by separating the overlapped characters is determined, an image, from which a line other than characters is eliminated when the selecting object is generated, (an image including the character “ [symbol] ” only) is copied or shifted.

(Flow of Processes)

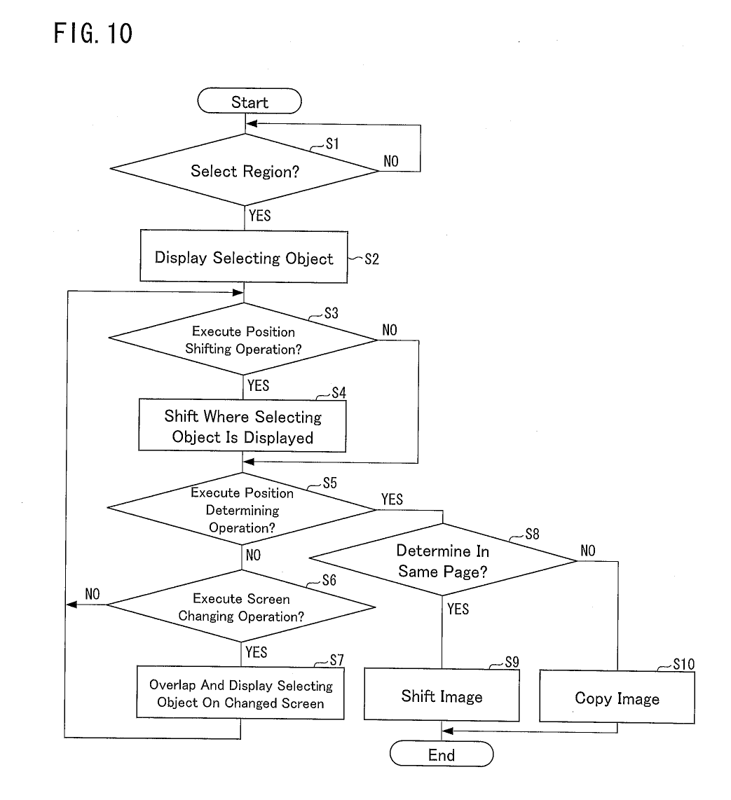

The following describes a flow of processes executed by the electronic notebook device 100, with reference to FIG. 10. FIG. 10 is a flowchart illustrating one example of processes executed by the electronic notebook device 100. Note that it is assumed that the art knife 213 has been already selected from the tool box 210.

When the operation determining section 16 receives, from the tool managing section 15, a signal indicating that the art knife 213 is being selected, the operation determining section 16 confirms whether or not a region selection has been executed (S1). Specifically, the operation determining section 16 determines that a region selection has been executed, in a case where the operation determining section 16 detects an operation of surrounding a partial region of the display screen on the position inputting section 122 by use of the touch pen 151.

The operation determining section 16 can also determine that a region selection has been executed, in a case where the operation determining section 16 detects an operation of surrounding a partial region of the display screen on the position inputting section 122 by use of, for example, the finger 152. In the present example, however, a region selection can be executed only by use of the touch pen 151 so that a user can feel as if the user actually cut a page by use of a knife.

In a case where the operation determining section 16 confirms that the region selection has been executed (YES in S1), the operation determining section 16 notifies the selected region image display processing section 17 and the shift and copy managing section 18 of (i) execution of the region selection and (ii) information indicative of a selected region.

The shift and copy managing section 18, which receives the notification, generates the shift and copy managing information 133, and causes the memory section 130 to store the shift and copy managing information 133. Specifically, the shift and copy managing section 18 identifies, with reference to the display page managing information 132 (see FIG. 3), a page to which the region notified by the operation determining section 16 belongs. The shift and copy managing section 18 generates copy image information (see FIG. 4) by associating, with information indicative of a range of the region thus notified, a page number of the page thus identified.

Further, the shift and copy managing section 18 generates display position information by associating, with a position of the region notified by the operation determining section 16, the page (i) to which the region notifies by the operation determining section 16 belongs and (ii) which is identified with reference to the display page managing information 132. Further, the shift and copy managing section 18 (i) generates the shift and copy managing information 133 by associating the display position information with the copy image information, and (iii) causes the memory section 130 to store the shift and copy managing information 133. Note that the position of the region may be represented by, for example, representative coordinates in the region.

The selected region image display processing section 17, which receives the notification, displays a selecting object (S2). Specifically, the selected region image display processing section 17 generates the selecting object showing a state where the selected region is floating up, by (i) reading out, from the electronic notebook information 131, an image in the region notified by the operation determining section 16, and (ii) carrying out an image process of shading the image thus read out.

The selected region image display processing section 17 supplies, to the display controlling section 10, (i) the selecting object and (ii) a “position” contained in the display position information of the shift and copy managing information 133. Then, the selected region image display processing section 17 causes the image to be displayed at the “position”. That is, the selecting object showing the state where the selected region is floating up is displayed at the “position” on the display section 121.

The present example describes a case where the selected region is set on the electronic notebook. However, the present example is not limited to the case. The selected region can be set in an image displayed due to the schedule management function section 11 or the internet function section 12.

A process carried out in a case where the selected region is set in the image displayed due to the schedule management function section 11 is identical to that carried out in the case where the selected region is set on the electronic notebook. A process carried out in a case where the selected region is set in the image displayed due to the internet function section 12 is identical to that carried out in the case where the selected region is set on the electronic notebook, except that a URL (Uniform Resource Locator) or the like is stored instead of a “page” of the copy image information of the shift and copy managing information 133.

While the selecting object is being displayed, the shift and copy managing section 18 confirms whether or not an input operation of shifting where the selecting object is displayed has been executed (S3). Specifically, the shift and copy managing section 18 identifies, on the basis of the position and the range indicated by the shift and copy managing information 133, the region where the selecting object is displayed. The shift and copy managing section 18 determines that the input operation of shifting where the selecting object is displayed has been executed, when the shift and copy managing section 18 receives, from the operation determining section 16, information indicating that the region has been touched and the region has been dragged while being touched.

In a case where the shift and copy managing section 18 confirms that the input operation of shifting where the selecting object is displayed has been executed (YES in S3), the shift and copy managing section 18 updates the “position” of the display position information of the shift and copy managing information 133 to where the region which is being touched is detected. The shift and copy managing section 18 (i) continues to update the “position” until completion of the dragging (until a touching state is cancelled), and (ii) notifies the selected region image display processing section 17 of the updating.

The selected region image display processing section 17, which receives the notification notifying of the updating, transmits, to the display controlling section 10, the “position” contained in the shift and copy managing information 133 which has been updated, so that where the selecting object is displayed is updated. This allows the display section 121 to display the selecting object which is shifting along a trace of the dragging, which selecting object shows the state where the selected region is floating up.

Note that the image in the selected region may be still displayed or may not be displayed after the selecting object is shifted. Alternatively, the image in the selected region may be still displayed when the selecting object is copied, and in contract, the image in the selected region may not be displayed when the selecting object is shifted.

In a case where where the selecting object is displayed has been shifted or in a case where the shift and copy managing section 18 does not confirm that the input operation of shifting where the selecting object is displayed has been executed (NO in S3), the shift and copy managing section 18 confirms whether or not an input operation of determining where the image is to be copied or shifted has been executed (S5). Specifically, the shift and copy managing section 18 identifies, on the basis of the position and the range indicated by the shift and copy managing information 133, the region where the selecting object is displayed. The shift and copy managing section 18 determines that the input operation of determining where the image is to be copied or shifted has been executed, when the shift and copy managing section 18 receives, from the operation determining section 16, information indicating that the region has been touched.

In a case where the shift and copy managing section 18 confirms that the input operation of determining where the image is to be copied or shifted has been executed (YES in S5), the electronic notebook device 100 proceeds to S8. On the other hand, in a case where the shift and copy managing section 18 does not confirm that the input operation of determining where the image is to be copied or shifted has been executed (No in S5), the electronic notebook device 100 proceeds to S6.

In S6, the shift and copy managing section 18 confirms whether or not a screen changing operation has been executed. Specifically, when the shift and copy managing section 18 receives, from the operation determining section 16, information indicating that a page turning operation has been executed, the shift and copy managing section 18 determines that the screen changing operation has been executed. When the function controlling section 14 has started up the schedule management function section 11 or the internet function section 12, the shift and copy managing section 18 also determines that the screen changing operation has been executed.

In a case where the shift and copy managing section 18 confirms that the screen changing operation has been executed (YES in S6), the shift and copy managing section 18 updates, on the basis of a screen obtained by execution of the screen changing operation, the display position information of the shift and copy managing information 133. For example, in a case where a page has been turned to another page, the shift and copy managing section 18 (i) obtains information on the another page from the display page managing information 132, and (ii) updates the “page” of the display position information to the another page. On the other hand, in a case where the shift and copy managing section 18 does not confirm that the screen changing operation has been executed (NO in S6), the electronic notebook device 100 returns to S3.

Note that a schedule notebook which is managed and provided by the schedule management function section 11 is different from the electronic notebook in that data of the schedule notebook is managed on the basis of date. However, processes carried out in a case where a screen changing operation due to startup of the schedule management function section 11 is executed are identical to those carried out in a case where the page turning operation is executed, except that the display position information stores information indicative of “date” of the schedule notebook instead of the “page”. In a case where a screen changing operation due to startup of the internet function section 12 is carried out, the display position information stores a URL instead of the “page”.

The selected region image display processing section 17 continues to cause the selecting object to be displayed even after the screen changing operation is carried out. This causes t he selecting object to be overlapped on the screen obtained by execution of the screen changing operation (S7). Then, the electronic notebook device 100 returns to S3.

In S8, the shift and copy managing section 18 determines whether or not a position determining operation has been executed on the same page as the page on which the image is to be copied. Specifically, the shift and copy managing section 18 determines that the position determining operation has been executed on the same page as the page on which the image is to be copied, in a case where the “page” of the copy image information of the shift and copy managing information 133 is identical to the “page” of the display position information of the shift and copy managing information 133.

In a case where the shift and copy managing section 18 determines that the position determining operation has been executed on the same page as the page on which the image is to be copied (YES on S8), the shift and copy managing section 18 shifts the image (S9). Specifically, the shift and copy managing section 18 (i) reads out, from the electronic notebook information 131, page managing information of a page identified by the “page” of the copy image information of the shift and copy managing information 133, (ii) cuts out the image in a region identified by the “range” of the copy image information of the shift and copy managing information 133, the image being edit information of the page managing information, and then (iii) pastes the image on a position identified by the “position” of the shift and copy managing information 133.

The shift and copy managing section 18 further notifies the selected region image display processing section 17 that the position determining operation has been executed. The selected region image display processing section 17 receives the notification, and instructs the display controlling section 10 to cause the display section 121 (i) not to display the selecting object and (ii) to carry out display based on updated electronic notebook information 131. This makes it possible to shift, on the same page, the image in the selected region. Thus, the electronic notebook device 100 completes the processes.

On the other hand, in a case where the shift and copy managing section 18 determines that the position determining operation has been executed on a page other than the page on which the image is to be copied (NO in S8), the shift and copy managing section 18 copies the image to the page other than the page on which the image is to be copied (S10). Specifically, the shift and copy managing section 18 (i) reads out, from the electronic notebook information 131, page managing information of a page identified by the “page” of the copy image information of the shift and copy managing information 133, (ii) copies the image in a region identified by the “range” of the copy image information of the shift and copy managing information 133, the image being edit information of the page managing information, and (iii) pastes the image on a position identified by the “page” and the “position” of the display position information of the shift and copy managing information 133. Note that the image to be copied may be obtained by requiring the selected region image display processing section 17 to provide the image on the basis of which the selecting object is generated. This makes it possible to copy the image in the selected region onto the page other than the page on which the image has been copied. Thus, the electronic notebook device 100 completes the processes.

(Example of How to Copy in Case of Page Division: Copy on Divided Pages)

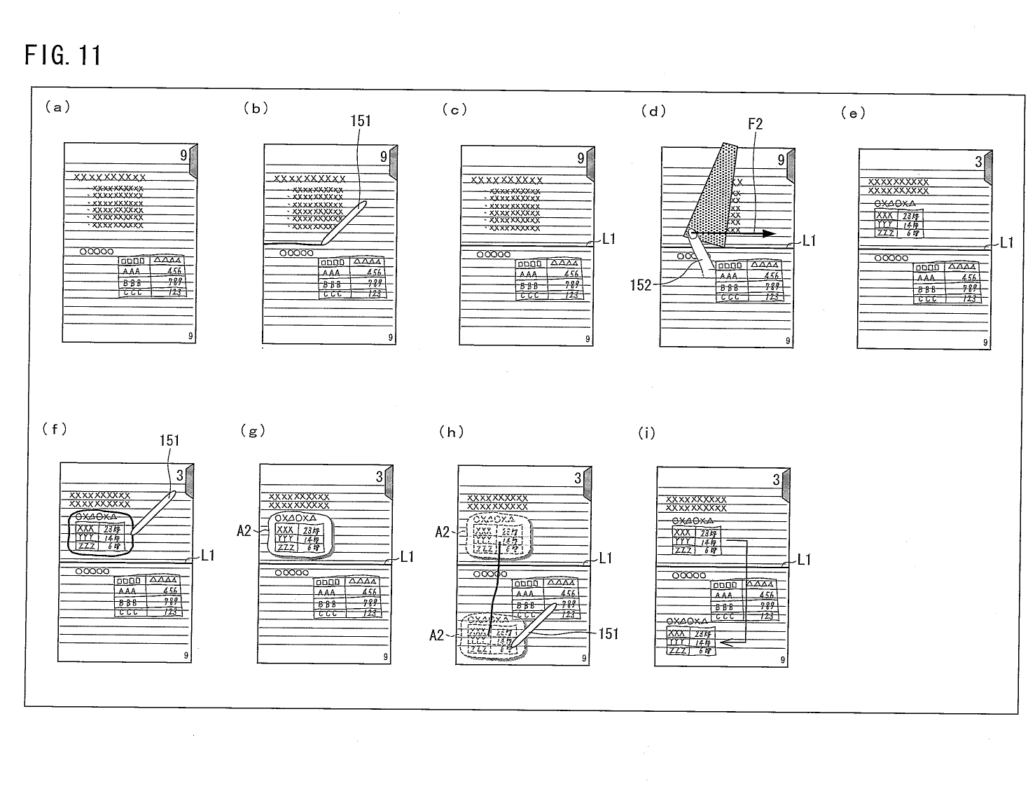

Next, a specific example of how to copy an image in a case of page division will be described below with reference to FIG. 11. (a) through (i) of FIG. 11 illustrate an example in which a page is divided and then an image on a page is copied to another page.

(a) of FIG. 11 illustrates a page (page 9) containing an image to be copied. First, where the page is divided is drawn by use of the touch pen 151 as illustrated in (b) of FIG. 11, while the art knife 213 is being selected.

In a case where a line drawn by the touch pen 151 connects an edge of the page and another edge of the page (in a case where the page is divided into two or more regions), the line is displayed as a page dividing line L1 as illustrated in (c) of FIG. 11.

Pages obtained by division of the page along the page dividing line L1 can be individually turned. This makes it possible to simultaneously display a plurality of pages on one screen. For example, as illustrated in (d) of FIG. 11, in a case where the region above the page dividing line L1 is flicked in a direction indicated by an arrow F2, an animation of turning page 9 back to page 8 is displayed, and then page 9 is turned back to page 8. On the other hand, the region below the page dividing line L1 continues to display page 9.

Thus, a user can (i) divide a region o n the electronic notebook device 100 as if the user cuts a paper notebook by use of a knife, (ii) individually turn pages of respective divided regions, and (iii) find a page on which desired information is displayed. In other words, a user can operate the electronic notebook device 100 intuitively as if the user uses an actual stationery.

In the present example, it is assumed that desired information is found on page 3 (in the region above the page dividing line L1) as illustrated in (e) of FIG. 11. Note that the region below the page dividing line L1 is still on page 9. The desired information is surrounded by use of the touch pen 151, as illustrated in (f) of FIG. 11.

An image in a region thus surrounded is displayed as a selecting object A2, as illustrated in (g) of FIG. 11. The selecting object A2 can be freely shifted within the region above the page dividing line L1 and to the region below the page dividing line L1.

In the present example, it is assumed that where the image is to be copied is determined by (i) dragging the selecting object A2 to the region below the page dividing line L1 with the use of the touch pen 151 and then (ii) touching the selecting object A2 (see (h) of FIG. 11). This makes it possible to copy, to page 9, the image on page 3, on the basis of which image the selecting object A2 is generated (see (i) of FIG. 11). Note that an operation of shifting the selecting object A2 and an operation of determining where the image is to be copied can also be carried out by use of the finger 152.

Thus, the electronic notebook device 100 can carry out copying while simultaneously displaying (i) a divided page including an image to be copied and (ii) a divided page on which the image is to be pasted. This improves user's operability to the electronic notebook device 100.

(Example of how to Copy in Case of Page Division: Designation of Selected Region which Extends Over Divided Pages)

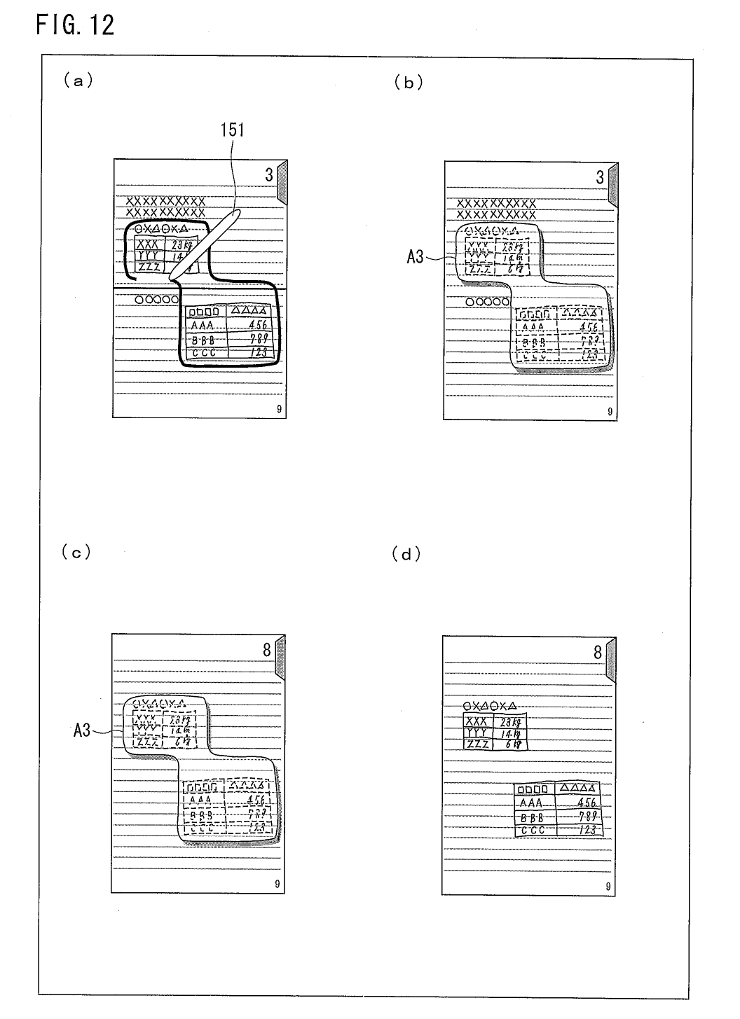

The following describes, with reference to FIG. 12, another example of how to copy in a case of page division. (a) through (d) of FIG. 12 exemplify a case where a page is divided and then a selected region extending over divided pages is designated. Note that a series of operations from page division to display of a page to be copied is the same as those illustrated in (a) through (e) of FIG. 11.

As illustrated in (a) of FIG. 12, in a case where (i) a page is divided into a plurality of pages on one screen, and (ii) images are displayed on the plurality of respective pages on the screen, a range extending over the plurality of pages can be designated as a selected region by being surrounded by use of the touch pen 151.

In a case where the range extending over the plurality of pages is designated as the selected region, page division is cancelled as illustrated in (b) of FIG. 12. In (b) of FIG. 12, a page displayed after the cancelling is a page of a region above a page dividing line (a page of a region in which a page number of the page is displayed). However, the page displayed after the cancelling is not limited to the page of the region above the page dividing line, but may be a page of a region below the page dividing line or a blank page (a newly added page). A selecting object A3 is displayed as with the example of FIG. 11.

It is possible to search for where the selecting object A3 is to be copied, by carrying out a page turning operation while the selecting object A3 is being displayed. In the present example, page 8 is supposed to be a destination where copying is carried out (see (c) of FIG. 12).

An image on the basis of which the selecting object A3 is generated is copied onto page 8 as illustrated in (d) of FIG. 12 by determining where the image is to be copied. The determining is carried out by touching the selecting object A3 while page 8 is being displayed.

Thus, the electronic notebook device 100 can copy, as one image, the image which extends over the plurality of divided pages. This improves user's operability to the electronic notebook device 100.

(Flow of Processes in Case of Page Division)

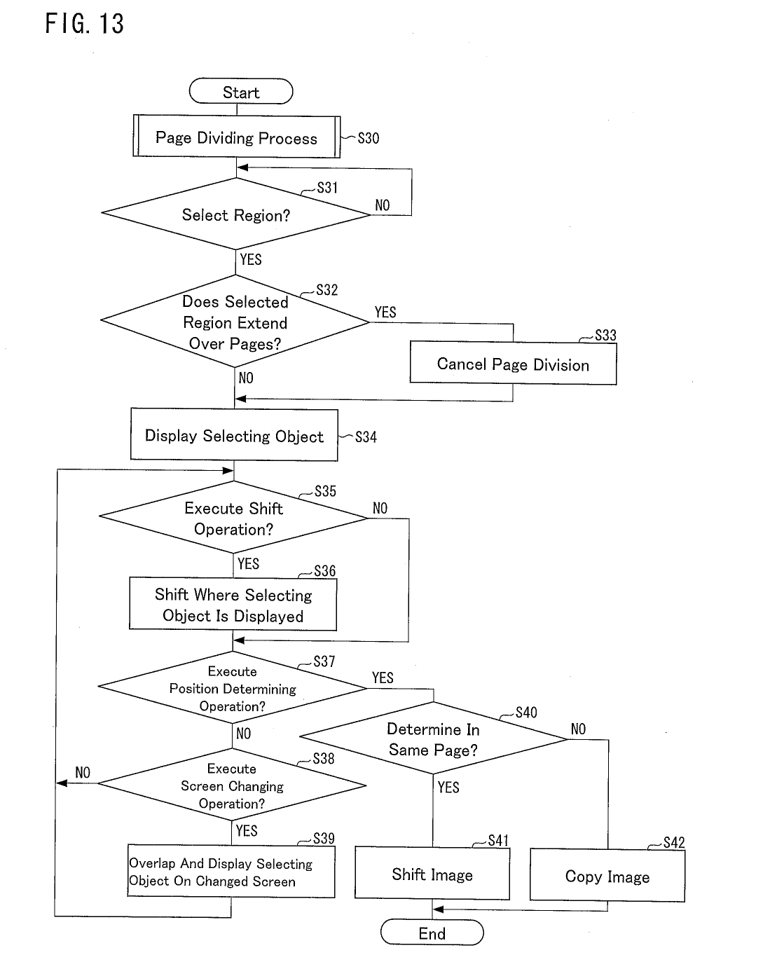

The following describes, with reference to FIG. 13, a flow of processes carried out by the electronic notebook device 100 in a case of page division. FIG. 13 is a flowchart exemplifying the processes carried out by the electronic notebook device 100 in the case of page division. Note here that it is supposed that the art knife 213 has been already selected from the tool box 210.

A page dividing process is carried out (S30) by drawing a division line as illustrated in (b) of FIG. 11 while the art knife 213 is being selected. By the page dividing process, a screen is divided as illustrated in (c) of FIG. 11. The page dividing process will be specifically described later.

Even in the case where the page division is carried out, the operation determining section 16 confirms whether or not an input operation of surrounding a region of the display screen has been carried out on the position inputting section 122 by use of the touch pen 151, that is, whether or not a region selection has been carried out (S31), as with the example of FIG. 10.

In a case where the operation determining section 16 confirms that the region selection has been carried out (YES in S31), the operation determining section 16 notifies the selected region image display processing section 17 and the shift and copy managing section 18 of (i) execution of the region selection and (ii) information indicative of a selected region.

The shift and copy managing section 18 receives the notification, and confirms whether or not the selected region extends over a plurality of pages (S32). Specifically, the shift and copy managing section 18 determines, with reference to the display page managing information 132 (see FIG. 3), whether or not the selected region notified by the operation determining section 16 extends over the plurality of pages.

In a case where the shift and copy managing section 18 confirms that the selected region extends over the plurality of pages (YES in S32), the shift and copy managing section 18 instructs the electronic notebook function section 13 to cancel the page division. The electronic notebook function section 13, which receives the instruction, cancels the page division by updating the electronic notebook information 131 so that information on divided pages is cancelled. It is considered that an image which extends over a plurality of pages frequently occupies a relatively broad area. It is therefore considered preferable that where the image is to be shifted or copied be searched for on an undivided page.

In contrast, in a case where the shift and copy managing section 18 confirms that the selected region does not extend over the plurality of pages (NO in S32), the shift and copy managing section 18 generates the shift and copy managing information 133, and causes the memory section 130 to store the shift and copy managing information 133 as with the example of FIG. 10. Then, the electronic notebook device 100 proceeds to S34.

Even in a case where the page division is cancelled, the shift and copy managing section 18 generates the shift and copy managing information 133 and causes the memory section 130 to store the shift and copy managing information 133. Specifically, the shift and copy managing section 18 (i) identifies, with reference to the display page managing information 132, a page to which the selected region notified by the operation determining section 16 belongs, and (ii) generates copy image information by associating, with information indicative of a range of the selected region thus notified, a page number of the page thus identified. Then, the electronic notebook device 100 proceeds to S34.

In the present example, the selected region extends over the plurality of pages. Therefore, the shift and copy managing section 18 generates the “page” and the “range” of the copy image information for each of the plurality of pages. For example, in a case where a selected region extends over page 3 and page 5, the shift and copy managing section 18 generates, as the “page” of the copy image information, pieces of information indicative of respective pages 3 and 5, and associates, with the pieces of information indicative of the respective pages 3 and 5, pieces of information indicative of the “range” of the respective pages 3 and 5.

In S34, the selected region image display processing section 17 displays a selecting object upon reception of the notification (S34). Specifically, the selected region image display processing section 17 generates the selecting object showing a state where the selected region is floating up, by (i) reading out, from the electronic notebook information 131, the image in the selected region notified by the operation determining section 16, and (ii) carrying out an image process of shading the image thus read.

Note that, in the case where the selected region extends over the plurality of pages, the selected region image display processing section 17 generates the selecting object by (i) cutting, from the electronic notebook information 131, images on the plurality of respective pages, the images being included in the selected region, (ii) combining the images, and (iii) carrying out an image process of shading the images thus combined (a composite partial image).

Processes of S35 through S42 are identical to respective processes of S3 through S10 of FIG. 10. As early described, the plurality of pages can be displayed on one screen by page division. The page dividing process reflects, in the display position information of the shift and copy managing information 133, a page to which a divided region of a plurality of divided regions that are made by the page division belongs, the divided region including a position determined as where the composite partial image is to be copied or shifted. Therefore, in the case where the page division is carried out, an image on the basis of which the selecting object is generated is copied or shifted onto an image displayed in the divided region of the plurality of divided regions, which divided region includes the position thus determined, though the processes of S35 through S42 carried out in the case of page division are identical to those of S3 through S10 of FIG. 10. By carrying out the processes, it is possible to carry out the copying (illustrated in FIGS. 11 and 12) in the case of page division.

(Flow of Page Dividing Process)

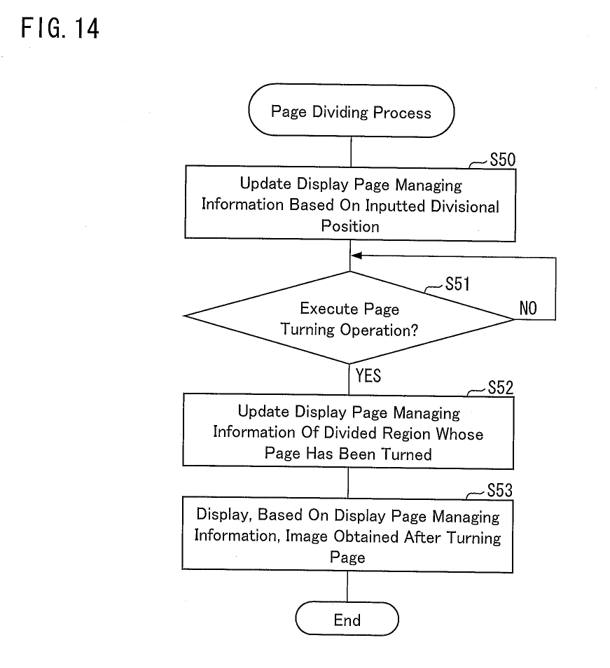

The following describes, with reference to FIG. 14, a flow of the page dividing process carried out in S30 of FIG. 13. FIG. 14 is a flowchart exemplifying the page dividing process. Note that what is described here is processes to be carried out after the operation determining section 16 detects an operation of inputting, by use of the touch pen 151, where to be divided while the art knife 213 is being selected. Specifically, where to be divided is inputted by drawing a line connecting edges of a page. Where to be divided is not limited to a specific one such as a line connecting a left edge and a right edge of a page, but may be a line connecting an upper edge and a lower edge of the page, a line connecting the left edge and the upper edge, or like line. Alternatively, where to be divided may be a line connecting an identical edge (such as a line connecting a point of a left edge of a page and another point of the left edge). Further, the line may be a straight line, a curved line, a line itself drawn by a user, or a line obtained by approximating a drawn line to a straight line or to a curved line. Note, however, that in a case where a region is designated by a line having no end by use of the art knife 213, the region thus designated is determined as a region to be copied or shifted.

The operation determining section 16 supplies, to the electronic notebook function section 13, information indicative of where to be divided (for example, information indicative of, by e.g., coordinates, where to be divided) which has been inputted. The electronic notebook function section 13, which receives the information, updates the display page managing information 132 on the basis of where to be divided (S50). Specifically, the electronic notebook function section 13 updates the display page managing information 132 by (i) identifying, as divided regions, regions surrounded by where to be divided and a peripheral part of a page, (ii) confirming the number of the divided regions into which the page is divided, (iii) assigning names (or for example, reference numbers) such as a “division a” and a “division b” to the respective divided regions, and (iv) associating, with pieces of information indicative of the respective divided regions thus identified, pages to which the respective divided regions belong.

The operation determining section 16 waits for execution of a page turning operation (S51). When the operation determining section 16 confirms that the page turning operation (a rightward or leftward flick) has been executed (YES in S51), the operation determining section 16 notifies the electronic notebook function section 13 of (i) execution of the page turning operation, (ii) information indicative of whether a page is turned to a next page or to a back page, and (iii) information indicative of where the page turning operation has been executed.

The electronic notebook function section 13, which receives the pieces of information, updates the display page managing information 132 of a divided region whose page has been turned (S52). Specifically, the electronic notebook function section 13 identifies the divided region whose page has been turned, on the basis of (i) the information indicative of where the page turning operation has been executed and (ii) the “divided region” of the display page managing information 132. Then, the electronic notebook function section 13 updates, on the basis of the pieces of information, the “page” of the divided region whose page has been turned. For example, in a case where (i) the “page” indicates “6” before updating and (ii) the electronic notebook function section 13 receives information indicating that a page has been turned to a next page, the electronic notebook function section 13 updates the “page” to “7”.

The electronic notebook function section 13 then causes an image obtained after execution of the page turning operation to be displayed, on the basis of the display page managing information 132 thus updated. This completes the page dividing process.

### CONCLUSION

The present invention is not limited to the description of the embodiments above, and can therefore be modified by a skilled person in the art within the scope of the claims. Namely, an embodiment derived from a proper combination of technical means disclosed in different embodiments is encompassed in the technical scope of the present invention.

The above has described a case where blocks of the electronic notebook device 100, particularly the main control section. 110 is realized by software with the use of a CPU.

That is, the electronic notebook device 100 includes a CPU (central processing unit), a ROM (read only memory), a RAM (random access memory), and a memory device (recording medium) such as a memory. The CPU executes instructions in control programs for realizing each function. The ROM contains the control programs, the control programs are loaded on the RAM, and the memory device stores the control programs and various data. The objective of the present invention can also be achieved, by mounting, to the electronic notebook device 100, a computer-readable recording medium recording control program codes (executable program, intermediate code program, or source program) for the electronic notebook device 100, serving as software for realizing the foregoing respective functions, so that the computer (or CPU or MPU) retrieves and executes the control program codes recorded in the recording medium.

The recording medium can be, for example, a tape, such as a magnetic tape or a cassette tape; a disk including (i) a magnetic disk such as a floppy (Registered Trademark) disk or a hard disk and (ii) an optical disk such as CD-ROM, MO, MD, DVD, or CD-R; a card such as an IC card (memory card) or an optical card; or a semiconductor memory such as a mask ROM, EPROM, EEPROM, or flash ROM.

Alternatively, the electronic notebook device 100 can be arranged to be connectable to a communications network so that the control program codes are delivered over the communications network. The communications network is not limited to a specific one, and therefore can be, for example, the Internet, an intranet, extranet, LAN, ISDN, VAN, CATV communications network, virtual dedicated network (virtual private network), telephone line network, mobile communications network, or satellite communications network. The transfer medium which constitutes the communications network is not limited to a specific one, and therefore can be, for example, wired line such as IEEE 1394, USB, electric power line, cable TV line, telephone line, or ADSL line; or wireless such as infrared radiation (IrDA, remote control), Bluetooth (Registered Trademark), 802.11 wireless, HDR, mobile telephone network, satellite line, or terrestrial digital network. Note that the blocks of the electronic notebook device 100 can be realized by hardware logic.

Thus, an information processing device of the present invention is configured to include: object display processing means for generating a selecting object and causing the display section to display the selecting object, the selecting object being generated on the basis of a partial image of an image displayed on the display section, which partial image is included in a region designated by a user operation, and the selecting object thus generated including the partial image and being for use to select, by shifting the selecting object on the image displayed on the display section, where the partial image is to be shifted or copied; and shifting or copying means for performing shifting or copying of the partial image in such a manner that, in a case where a user operation which determines a final destination of the selecting object thus shifted by the shifting is detected, the partial image on the basis of which the selecting object is generated is shifted or copied to the final destination of the selecting object thus shifted by the shifting, when a page of the image displayed on the display section is changed to another page, the object display processing means displaying the selecting object on the another page.

Therefore, a user can copy or shift an image by (i) designating a region to be copied or shifted, (ii) finding a desired image by means of page-based change of the image, (iii) considering where the selecting object is to shifted or copied by shifting the selecting object on the desired image thus found, and then (iv) determining, on the desired image, a desired destination to which the partial image is to be shifted or copied. That is, a user can easily copy or shift, onto another image, a part of an image, which part is included in a designated region.

It is preferable to configure the information processing device so as to further include: page identifying information recording means for recording page identifying information which identifies a page on which the partial image was included; and image correspondence determining means for, in the case where the user operation to determine the final destination of the selecting object thus shifted by the shifting is detected, determining whether or not an image displayed on the display section is identical with the image which included the partial image, the image correspondence determining means performing the determining with reference to the page identifying information recorded by the page identifying information recording means, the shifting or copying means performing the shifting of the partial image in a case where the image correspondence determining means determines that the image displayed on the display section is identical with the image which included the partial image, and in contrast, the shifting or copying means performing the copying of the partial image in a case where the image correspondence determining means determines otherwise.

It is generally considered that, in a case where a displayed image is like a handwritten note, there is not much point in displaying the handwritten notes on the same page. It is therefore unlikely to copy the image onto the same page. On the other hand, in a case where what is written on a page is shifted onto another page, what is written on the page is deleted from the page on which a user remembers writing. The case is not preferable. That is, depending on types of an image which is being displayed or an application for causing the image to be displayed, there is a case where it is unlikely to copy the image onto the same page, and there is a case where it is not preferable to shift the image to a different page.

According to the configuration, whether or not an image displayed on the display section is identical with the image which included the partial image is determined. In a case where it is determined that the image displayed on the display section is identical with the image which included the partial image, the shifting of the partial image is performed. In contrast, in a case where it is determined otherwise, the copying of the partial image is performed.

This makes it possible to, without any special user operations, (i) prevent identical information from being copied in an identical page, and (ii) prevent search of information which was included in a page from becoming difficult. Such difficulty is caused by shift of the information to another page.

It is preferable to configure the information processing device so as to further include: region division controlling means for (i) dividing the display section into a plurality of regions, and (ii) individually changing images displayed on the plurality of respective regions, the shifting or copying means performing the shifting or copying of the partial image in such a manner that, in the case where the user operation to determine the final destination of the selecting object thus shifted by the shifting is detected, the partial image on the basis of which the selecting object is generated is shifted or copied to an image displayed on a region of the plurality of regions, which region includes the final destination of the selecting object.

According to the configuration, the display section is divided into a plurality of regions, and images displayed on the plurality of respective regions are individually changed. Further, in the case where the final destination of the selecting object thus shifted by the shifting is determined, the partial image is shifted or copied to an image displayed on a region of the plurality of regions, which region includes the final destination of the selecting object.

Therefore, according to the configuration, images on respective different pages can be concurrently displayed on one screen, and a partial image can be copied or shifted to the images thus concurrently displayed on the screen. That is, according to the configuration, a user can carry out copying or shifting while confirming, on one screen, an image to be copied or shifted and an image to be copied or shifted. This further improves user's operability.

It is preferable to configure the information processing device so as to further include: region division controlling means for (i) dividing the display section into a plurality of regions, and (ii) individually changing images displayed on the plurality of respective regions, in a case where a user operation designates a range extending over two or more of the plurality of regions, the object display processing means (i) generating a composite partial image by combining a plurality of partial images which are included in the range and derived from the respective images, (ii) generating a selecting object on the basis of the composite partial image, and (iii) causing the display device to display the selecting object, in the case where the user operation to determine the final destination of the selecting object thus shifted by the shifting is detected, the shifting or copying means performing shifting or copying of the composite partial image in such a manner that the composite partial image on the basis of which the selecting object is generated is shifted or copied to the final destination of the selecting object.

According to the configuration, in a case where a range extending over two or more of the plurality of region is designated, (i) a composite partial image is generated by combining a plurality of partial images which are included in the range and derived from the respective images, (ii) a selecting object is generated on the basis of the composite partial image, and (iii) the selecting object is displayed. In the case where the final destination of the selecting object thus shifted by the shifting is determined, the composite partial image on the basis of which the selecting object is generated is shifted or copied.

That is, according to the configuration, it is possible to (i) provide a user with partial images which originally belong to respective different pages, as a selecting object in which the partial images are combined, and (ii) copy or shift the partial images as a composite partial image in which the partial images are combined. This makes it possible to copy or shift a collection of a plurality of partial images; thereby improving user's convenience.

The information processing device can be realized by a computer. In a case where the information processing device is realized by a computer, the present invention encompasses (i) a control program for causing the information processing device to be realized by the computer, the control program causing the computer to function as the means, and (ii) a computer-readable recording medium, in which the control program is recorded.

### INDUSTRIAL APPLICABILITY

The present invention is suitably applicable to, for example, tablet PCs and mobile terminals for causing a display section to display an image which is changeable by page-based change.

### REFERENCE SIGNS LIST

13: electronic notebook function section (region division controlling means)
17: selected region image display processing section (object display processing means)
18: shift and copy managing section (shifting or copying means, page identifying information recording means, image correspondence determining means)
100: electronic notebook device (information processing device)

1. An information processing device for causing a display section to display an
image which is changeable by page-based change, comprising:
object display processing means for generating a selecting object and causing the display section to display the selecting object, the selecting object being generated on the basis of a partial image of an image displayed on the display section, which partial image is included in a region designated by a user operation, and the selecting object thus generated including the partial image and being for use to select, by shifting the selecting object on the image displayed on the display section, where the partial image is to be shifted or copied; and
shifting or copying means for performing shifting or copying of the partial image in such a manner that, in a case where a user operation which determines a final destination of the selecting object thus shifted by the shifting is detected, the partial image on the basis of which the selecting object is generated is shifted or copied to the final destination of the selecting object thus shifted by the shifting,
when a page of the image displayed on the display section is changed to another page, the object display processing means displaying the selecting object on the another page.

2. The information processing device as set forth in claim 1, further comprising:
page identifying information recording means for recording page identifying information which identifies a page on which the partial image was included; and
image correspondence determining means for, in the case where the user operation to determine the final destination of the selecting object thus shifted by the shifting is detected, determining whether or not an image displayed on the display section is identical with the image which included the partial image, the image correspondence determining means performing the determining with reference to the page identifying information recorded by the page identifying information recording means,
the shifting or copying means performing the shifting of the partial image in a case where the image correspondence determining means determines that the image displayed on the display section is identical with the image which included the partial image, and in contrast, the shifting or copying means performing the copying of the partial image in a case where the image correspondence determining means determines otherwise.

3. The information processing device as set forth in claim 1, further comprising:
region division controlling means for (i) dividing the display section into a plurality of regions, and (ii) individually changing images displayed on the plurality of respective regions,
the shifting or copying means performing the shifting or copying of the partial image in such a manner that, in the case where the user operation to determine the final destination of the selecting object thus shifted by the shifting is detected, the partial image on the basis of which the selecting object is generated is shifted or copied to an image displayed on a region of the plurality of regions, which region includes the final destination of the selecting object.

4. The information processing device as set forth in claim 1, further comprising:
region division controlling means for (i) dividing the display section into a plurality of regions, and (ii) individually changing images displayed on the plurality of respective regions,
in a case where a user operation designates a range extending over two or more of the plurality of regions, the object display processing means (i) generating a composite partial image by combining a plurality of partial images which are included in the range and derived from the respective images, (ii) generating a selecting object on the basis of the composite partial image, and (iii) causing the display device to display the selecting object,
in the case where the user operation to determine the final destination of the selecting object thus shifted by the shifting is detected, the shifting or copying means performing shifting or copying of the composite partial image in such a manner that the composite partial image on the basis of which the selecting object is generated is shifted or copied to the final destination of the selecting object.

5. A method for controlling an information processing device for causing a display section to display an image which is changeable by page-based change, comprising:
an object display processing step of (i) generating a selecting object and causing the display section to display the selecting object, the selecting object being generated on the basis of a partial image of an image displayed on the display section, which partial image is included in a region designated by a user operation on the information processing device, and the selecting object thus generated including the partial image and being for use to select, by shifting the selecting object on the image displayed on the display section, where the partial image is to be shifted or copied;
a step of, when a page of the image displayed on the display section is changed to another page, displaying, on the another page, the selecting object displayed by the object display processing step; and
a shifting or copying step of performing shifting or copying of the partial image in such a manner that, in a case where the information processing device detects a user operation which determines a final destination of the selecting object thus shifted by the shifting, the partial image on the basis of which the selecting object is generated is shifted or copied to the final destination of the selecting object thus shifted by the shifting.

6. (canceled)

7. A non-transitory computer-readable recording medium, in which a control program for causing the information processing device as set forth in claim 1 to operate, the control program causing a computer to function as the means is recorded.
